(19) United States
(12) Patent Application Publication
(10) Pub. No.: US 2025/0068492 A1
(43) Pub. Date: Feb. 27, 2025

(54) METHOD, APPARATUS, ELECTRONIC DEVICE AND STORAGE MEDIUM FOR DATA PROCESSING

(71) Applicant: Beijing Zitiao Network Technology Co., Ltd., Beijing (CN)

(72) Inventors: Pei ZHOU, Beijing (CN); Lu TAO, Beijing (CN); Zhikun GAO, Beijing (CN); Kui LI, Beijing (CN)

(21) Appl. No.: 18/814,327

(22) Filed: Aug. 23, 2024

(30) Foreign Application Priority Data
Aug. 24, 2023 (CN) 202311077172.4

(51) Int. Cl. G06F 9/54

(52) U.S. Cl. CPC G06F 9/543

(57) ABSTRACT

Embodiments of the present disclosure provide a method, an apparatus, an electronic device, and a storage medium for data processing. The method comprises: in response to a copy trigger operation, obtaining an object to be copied, and determining a target component corresponding to the object to be copied; for each of the target component, obtaining a component object and an engine object of the target component, and determining target storage data corresponding to the target component based on the component object and the engine object, wherein the target storage data comprises a component object type field, an engine object type field, component object serialized data, and engine object serialized data; and storing the target storage data corresponding to the target component into a clipboard.

### CROSS-REFERENCE

The present application claims priority to Chinese Patent Application No. 202311077172.4, filed on Aug. 24, 2023, and entitled “METHOD, APPARATUS, ELECTRONIC DEVICE AND STORAGE MEDIUM FOR DATA PROCESSING”, the entirety of which is incorporated herein by reference.

### FIELD

Embodiments of the present disclosure relate to the field of computer technologies, and in particular, to a method, an apparatus, an electronic device, and a storage medium for data processing.

### BACKGROUND

The Entity-Component-System (ECS) architecture is widely used in the development of Internet applications and games. In an ECS architecture, a component is a core element that constitutes an entity object and a behavior. Performing copy operation on the component facilitates fast reuse of the component. Thereby, an existing component function can be expanded, and time for designing and developing the function is saved.

In the prior art, when the component is copied, the attribute data of the component needs to be obtained, and the engine object corresponding to the component and the attribute data of the component are stored to the clipboard, so as to complete the copy operation on the component. The defects in the prior art include at least: the problem of memory leakage or program crash due to the fact that the engine object is stored in the clipboard in the copying process and the engine object in the clipboard tends to couple with the entity engine; moreover, copying the engine object and the attribute data to the clipboard causes the clipboard to occupy a large amount of the memory, the data format is chaotic, and maintenance is not convenient.

### SUMMARY

The present disclosure provides a data processing method, so as to reduce the memory occupation, improve the system stability, and render the data format stored in the clipboard simplified, clean and convenient to maintain.

According to a first aspect, an embodiment of the present disclosure provides a data processing method, including: in response to a copy trigger operation, obtaining an object to be copied, and determining a target component corresponding to the object to be copied; for each of the target component, obtaining a component object and an engine object of the target component, and determining target storage data corresponding to the target component based on the component object and the engine object, wherein the target storage data comprises a component object type field, an engine object type field, component object serialized data, and engine object serialized data; and storing the target storage data corresponding to the target component into a clipboard.

According to a second aspect, an embodiment of the present disclosure further provides a data processing apparatus, including: a copy operation trigger module, configured for, in response to a copy trigger operation, obtaining an object to be copied, and determining a target component corresponding to the object to be copied; a storage data generation module, configured for, for each of the target component, obtaining a component object and an engine object of the target component, and determining target storage data corresponding to the target component based on the component object and the engine object, wherein the target storage data comprises a component object type field, an engine object type field, component object serialized data, and engine object serialized data; and a clipboard data storage module, configured for storing the target storage data corresponding to the target component into a clipboard.

According to a third aspect, an embodiment of the present disclosure further provides an electronic device, including: one or more processors; and a storage device, configured to store one or more programs, wherein the one or more programs, when executed by the one or more processors, cause the one or more processors to implement the data processing method according to any one of the embodiments of the present disclosure.

According to a fourth aspect, an embodiment of the present disclosure further provides a storage medium comprising computer-executable instructions, wherein the computer-executable instructions, when executed by a computer processor, perform the data processing method according to any one of the embodiments of the present disclosure.

### BRIEF DESCRIPTION OF DRAWINGS

The above-mentioned and other features, advantages, and aspects of various embodiments of the present disclosure will become more apparent from the following detailed description with reference to the accompanying drawings. Throughout the drawings, the same or similar reference numbers refer to the same or similar elements. It should be understood that the drawings are schematic, and components and elements are not necessarily drawn to scale.

FIG. 1 is a schematic flowchart of a data processing method according to an embodiment of the present disclosure;

FIG. 2 is a schematic flowchart of a further data processing method according to an embodiment of the present disclosure;

FIG. 3 is a schematic flowchart of a still further data processing method according to an embodiment of the present disclosure;

FIG. 4 is a schematic diagram of a format of storage data corresponding to a to-be-copied entity in a clipboard according to an embodiment of the present disclosure;

FIG. 5 is a schematic diagram of a copying process of a component to be copied according to an embodiment of the present disclosure;

FIG. 6 is a schematic diagram of a pasting process of a component to be copied according to an embodiment of the present disclosure;

FIG. 7 is a schematic diagram of a copying process of an entity to be copied according to an embodiment of the present disclosure;

FIG. 8 is a schematic diagram of a pasting process of an entity to be copied according to an embodiment of the present disclosure;

FIG. 9 is a schematic structural diagram of a data processing apparatus according to an embodiment of the present disclosure;

FIG. 10 is a schematic structural diagram of an electronic device according to an embodiment of the present disclosure.

### DETAILED DESCRIPTION

Embodiments of the present disclosure will be described in more detail below with reference to the accompanying drawings. While certain embodiments of the present disclosure are shown in the drawings, it should be understood that the present disclosure may be implemented in various forms, and should not be construed as limited to the embodiments set forth herein. On the contrary, these embodiments are provided for a more thorough and complete understanding of the present disclosure. It should be understood that the drawings and embodiments of the present disclosure are for illustrative purposes only and are not intended to limit the scope of the present disclosure.

It should be understood that the steps recited in the method embodiments of the present disclosure may be performed in different orders, and/or in parallel. Further, the method embodiments may include additional steps and/or omit performing the illustrated steps. The scope of the present disclosure is not limited in this respect.

As used herein, the term “comprise” and variations thereof are open-ended, i.e., “comprise but not limited to”. The term “based on” means “based at least in part on”. The term “an embodiment” means “at least one embodiment”. The term “a further embodiment” means “at least one further embodiment”. The term “some embodiments” means “at least some embodiments”. The relevant definition of other terms will be given below.

It should be noted that concepts such as “first” and “second” mentioned in the present disclosure are merely used to distinguish different apparatuses, modules, or units, and are not intended to limit the order of functions performed by the apparatuses, modules, or units or the mutual dependency relationship.

It should be noted that the modification of “a” and “a plurality” mentioned in the present disclosure is illustrative and not limiting, and those skilled in the art should understand that both shall be interpreted as “one or more”, unless the context clearly indicates otherwise.

The names of messages or information interacted between multiple apparatuses in embodiments of the present disclosure are for illustrative purposes only and are not intended to limit the scope of such messages or information.

It should be understood that, before the technical solutions disclosed in the embodiments of the present disclosure are used, the types, the usage scope, the usage scenario and the like of personal information related to the present disclosure should be notified to the user in an appropriate manner according to the relevant laws and regulations and obtain the authorization of the user.

For example, in response to receiving a voluntary request from a user, prompt information is sent to the user to explicitly prompt the user that the requested operation will need to acquire and use the personal information of the user. Therefore, the user can autonomously select whether to provide personal information to software or hardware executing the operation of the technical solution of the present disclosure according to the prompt information.

As an optional but non-limiting implementation, in response to receiving the voluntary request of the user, the manner of sending the prompt information to the user may be, for example, a pop-up window, and the prompt information may be presented in a text manner in the pop-up window. In addition, the pop-up window may further carry a selection control for the user to select “agree” or “disagree” to provide personal information to the electronic device.

It should be understood that the foregoing processes of notification and obtaining a user's authorization is merely illustrative, and do not constitute a limitation on implementations of the present disclosure, and other manners for meeting related laws and regulations may also be applied to implementations of the present disclosure.

It may be understood that the data involved in the present technical solutions (including but not limited to the data itself, the acquisition or use of the data) should follow the requirements of the corresponding laws and regulations and related regulations.

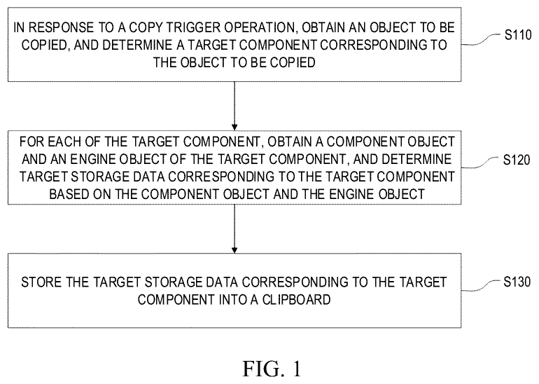

FIG. 1 is a schematic flowchart of a data processing method according to an embodiment of the present disclosure. Embodiments of the present disclosure are applicable to a scenario of copying a to-be-copied object in the ECS architecture to a clipboard. The method may be executed by a data processing apparatus, which may be implemented in the form of software and/or hardware. Alternatively, it may be implemented through an electronic device. The electronic device may be a mobile terminal, PC, server, or the like.

As shown in FIG. 1, the method of this embodiment may specifically include:

S110: in response to a copy trigger operation, obtain an object to be copied, and determine a target component corresponding to the object to be copied.

The object to be copied may be an action object of the copy trigger operation. In this embodiment, when it is detected that the copy trigger operation is triggered, an action object of the copy trigger operation is obtained and taken as the object to be copied. For example, the copy trigger operation may include operations such as clicking a “copy” control, inputting a “copy” voice instruction, and the like. The action object of the “copy” control or the voice instruction is obtained and taken as the object to be copied.

It should be noted that the ECS architecture includes three parts, i.e., entity, component and system. The component is an object with attribute data, the system is an object for processing data based on the component, and the entity comprises at least one sub-entity and/or at least one component; and the sub-entity may comprise at least one sub-entity and/or at least one component.

In a specific implementations, the object to be copied may be an entity and/or a component in the ECS architecture. The specific implementation of determining the target component corresponding to the object to be copied may include the following two implementations: 1. in response to that the object to be copied is a single component to be copied, determining the component to be copied as the target component; 2. in response to that the object to be copied is an entity to be copied, determining a component(s) comprised in the entity to be copied as the target component corresponding to the object to be copied.

In a specific implementation, when the object to be copied is the entity to be copied, the target component corresponding to the entity to be copied may be determined based on the data structure of the entity to be copied. For example, if it is determined, based on the data structure, that the entity to be copied is composed of components, the respective components constituting the entity to be copied may be determined as the target component. If it is determined, based on the data structure, that the entity to be copied includes the component and the sub-entity, a first component and a first sub-entity included in the entity to be copied may be determined, and then a second component and a second sub-entity included in the first sub-entity are determined based on a structure of sub-entities in the first sub-entity; based on a structure of sub-entities in the second sub-entity, a third component included in the second sub-entity is determined. For example, if the second sub-entity in the entity to be copied includes only the third component, the first component, the second component, and the third component may be determined as target components corresponding to the object to be copied. If the second sub-entity further includes a third sub-entity, proceeding to determine components included in the third sub-entity, until components of all sub-entities are determined, and each component is determined as a target component.

In this embodiment, the manner of determining the target component in a case where the object to be copied is a component and in a case where the object to be copied is an entity is described. This is beneficial to accurately determine a target component(s) based on a structure of the object to be copied.

S120: for each of the target component, obtain a component object and an engine object of the target component, and determine target storage data corresponding to the target component based on the component object and the engine object.

In this embodiment, the target component may include two parts, i.e., a component object and an engine object. When the target component has been determined, the component object and the engine object of the target component may be acquired accordingly. The target storage data corresponding to the target component is determined based on the component object and the engine object.

The target storage data comprises a component object type field, an engine object type field, component object serialized data, and engine object serialized data. The component object type field is used to reflect a component type of the target component. For example, in a scenario of game application, component types may include clothing types, weapon types, etc. The engine object type field is used to reflect the type of the engine corresponding to the target component. The component object serialized data and the engine object serialized data are data obtained after serialization processing.

In a specific implementation, the component characteristic data of the component object and the engine characteristic data of the engine object may be obtained. Information such as the type and the attribute of the component object is reflected through the component characteristic data, and information such as the type and the attribute of the engine object is reflected through the engine characteristic data. For example, attribute data such as a moving speed, a direction, and a position of the component object is determined by determining, based on the component characteristic data, whether the component object is a component of a moving type or a component of a static type.

In this embodiment, the component serialized data and the component type field may be determined through the component characteristic data; and the engine serialized data and the engine type field may be determined through the engine characteristic data. It should be noted that, the component characteristic data and the engine characteristic data may be set by those skilled in the art according to the application situation of the actual scenario when creating the target component.

In a specific implementation, determining the target storage data corresponding to the target component based on the component object and the engine object comprises: invoking a predefined component serialization interface; determining a component object type field corresponding to the component object and an engine object type field corresponding to the engine object; and obtaining the component object serialized data and the engine object serialized data by serializing component attribute data of the component object and engine attribute data of the engine object, respectively.

Specifically, before determining the target storage data, a component serialization interface may be defined, and the serialization processing of the data is implemented by invoking the component serialization interface. In a specific implementation, the component object type field of the component object is determined through the type information of the component object included in the component characteristic data of the component object; and the engine object type field of the engine object is determined through the type information of the engine object included in the engine characteristic data of the engine object.

Furthermore, the component attribute data included in the component characteristic data and the engine attribute data included in the engine characteristic data are determined. Attributes of the component object and attributes of the corresponding engine object are reflected by the component attribute data and the engine attribute data. For example, if the component object is a moving component object, the component attribute data includes data such as a position, a speed, and an orientation of the component object.

In a specific implementation, through invoking the component serialization interface, the component attribute data may be serialized to obtain the component object serialized data; and the engine attribute data may be serialized to obtain the engine object serialized data. The obtained component serialized data, the obtained engine serialized data, the component type field and the engine type field are combined to form the target storage data.

According to the embodiment, the serialization interface is invoked to obtain the component serialized data, the engine serialized data, the component type field and the engine type field. The component serialized data, the engine serialized data, the component type field and the engine type field form the target storage data. Thereby, the target storage data is more streamlined and cleaner, and the occupation of the memory can be advantageously reduced while the characteristic data of the target component is obtained.

S130: store the target storage data corresponding to the target component into a clipboard.

In a specific implementation, the clipboard may be used as a temporary storage area, and the target storage data corresponding to each target component may be stored in the clipboard. Further, in a case that the number of the target components is greater than a predetermined number, in order to avoid confusion of the target storage data stored in the clipboard, a unique identifier may be set for the target storage data corresponding to each target component, and the unique identifier and the target storage data are correspondingly stored into the clipboard, so that data confusion may be avoided when performing operations such as copying and pasting, and thus the operation accuracy can be improved.

According to the technical solutions of embodiments of the present disclosure, in response to a copy trigger operation, an object to be copied is obtained, and a target component corresponding to the object to be copied is determined, so as to complete a copy operation on the object to be copied by performing a copy operation on each of the target component; for each of the target component, a component object and an engine object of the target component is obtained, and target storage data corresponding to the target component is determined based on the component object and the engine object, so that the target storage data can reflect the characteristics of the component object and the engine object; and the target storage data corresponding to the target component is stored into a clipboard, so as to complete copying the target component. Since the target storage data comprises a component object type field, an engine object type field, component object serialized data, and engine object serialized data, i.e., the engine itself is not stored into the clipboard, the problem of memory leakage or program crash due to engine coupling is solved, meanwhile memory occupation caused by the copy operation is reduced, and thus system stability is improved. Furthermore, in aid of storing the component object type field, the engine object type field, the component object serialized data and the engine object serialized data into the clipboard, the data format stored in the clipboard is more simplified and cleaner, and easy to maintain.

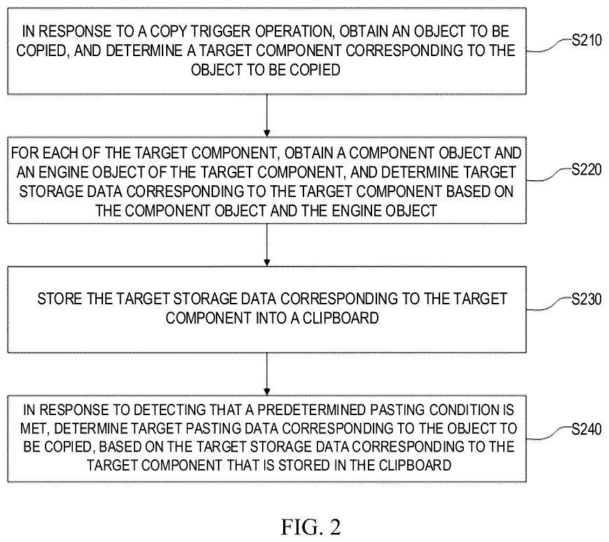

FIG. 2 is a schematic flowchart of a further data processing method according to an embodiment of the present disclosure. Based on the foregoing embodiment, after storing the target storage data corresponding to the target component into the clipboard, the technical solution of this embodiment further includes: in response to detecting that a predetermined pasting condition is met, determining target pasting data corresponding to the object to be copied, based on the target storage data corresponding to the target component that is stored in the clipboard. For a specific implementation, reference may be made to the description of this embodiment. Technical features that are identical or similar to the foregoing embodiments are not described herein again.

As shown in FIG. 2, the method of this embodiment may specifically include:

S210: in response to a copy trigger operation, obtain an object to be copied, and determine a target component corresponding to the object to be copied.

S220: for each of the target component, obtain a component object and an engine object of the target component, and determine target storage data corresponding to the target component based on the component object and the engine object.

S230: store the target storage data corresponding to the target component into a clipboard.

S240: in response to detecting that a predetermined pasting condition is met, determine target pasting data corresponding to the object to be copied, based on the target storage data corresponding to the target component that is stored in the clipboard.

The target pasting data may be data that is needed for pasting the object to be copied. For example, the target pasting data may be data reflecting information such as a type and an attribute of the object to be copied.

Specifically, when the target component is pasted, the corresponding component pasting data is determined based on the target storage data corresponding to the target component, and the target pasting data corresponding to the object to be copied is determined based on the component pasting data.

For example, when the object to be copied is a single component, the component pasting data may be directly determined as the target pasting data. When the object to be copied is an entity, the target pasting data may be constituted based on the component pasting data corresponding to respective target components, pasting of each target component is completed through the target pasting data, and thereby the operation for the object to be copied is completed.

In this embodiment, the predetermined pasting condition includes at least one of the following conditions: receiving a paste trigger operation inputted for the object to be copied; having a pasting permission for pasting the target component to a target pasting position; a paste operation permission being given for a to-be-pasted position corresponding to the target component; or an associated entity corresponding to the target component not comprising a component conflicting with the target component.

By way of example, it may be detected whether a paste trigger operation inputted for the object to be copied is received. If the paste trigger operation is received, it indicates that the predetermined pasting condition is currently met, and target pasting data corresponding to the object to be copied may be determined, so as to complete the paste operation on the object to be copied. If the paste operation is not received, it indicates that the predetermined pasting condition is currently not met, and thus the paste operation is not performed, in order to avoid an erroneous paste operation on the object to be copied.

Furthermore, in order to prevent the paste operation from failing, a perspective of a to-be-pasted position may be considered, and it is determined whether a paste operation permission is given for the to-be-pasted position. If the paste operation permission is given for the to-be-pasted position, whether the target component may be pasted to the to-be-pasted position may be further considered. If the paste operation permission is not given for the to-be-pasted position, the paste operation may be directly stopped, and prompt information is generated to be feedback to a user terminal, so as to prompt that the paste permission is not given for the to-be-pasted position. For example, the paste operation failing may be prompted by generating a pop-up window on a display interface of the user terminal.

Moreover, in order to ensure that the entity to which the target component belongs can work normally after the target component is pasted and improve the security in the operation process, the following may be taken as the predetermined pasting condition: whether the target component has the pasting permission for being pasted to the target pasting position, and/or an associated entity corresponding to the target component not comprising a component conflicting with the target component. Thereby, it can be ensured that after the paste operation is completed, the target component does not conflict with components in the associated entity, and the target component may work properly at the target pasting position.

According to the embodiment, the predetermined pasting condition is set, so that the target pasting data corresponding to the object to be copied is generated under the condition that the predetermined pasting condition is met. Thereby, a situation of erroneous pasting may be avoided, and thus the accuracy and effectiveness of the paste operation can be advantageously improved.

In order to save the storage space, improve the accuracy in the copying and pasting process, the data stored in the clipboard may be cleared after the target pasting data is determined, so as to be used for next storing. Alternatively, when it is detected that new data needs to be stored to the clipboard, the data currently stored in the clipboard may be cleared. Alternatively, in order to avoid the clipboard being occupied for a long time, the clipboard may be cleared when the storage duration of data in the clipboard reaches a predetermined storage duration. According to the embodiment, the clipboard is cleared in time. Thereby, the clipboard can be cleaner, the storage space can be saved, and thus the operation accuracy is improved for the subsequent copying and pasting process.

In this embodiment, the entity to which the target component after pasting belongs may be taken as an associated entity. At least one component may be included in the associated entity. In order to simplify the paste operation and improve the efficiency of the paste operation, before the target pasting data is determined, whether the associated entity includes a component identical to the target component may be detected.

Specifically, the manner of detecting whether the associated entity includes a component identical to the target component may includes: determining an associated entity to which the target component after being pasted belongs, and detecting components in the associated entity based on the component object type field corresponding to the target component. If a component corresponding to the component object type field exists in the associated entity, it may be determined that a component identical to the target component exists in the associated entity. If there is no component corresponding to the component object type field in the associated entity, it may be determined that there is no component identical to the target component in the associated entity.

In order to describe the process of obtaining the target pasting data more clearly and in detail, two cases may be illustrated in terms of whether the associated entity includes a component identical to the target component.
1. The associated entity to which the pasted target component belongs does not include a component identical to the target component.

Optionally, a specific implementation of determining the target pasting data corresponding to the object to be copied based on the target storage data corresponding to the target component that is stored in the clipboard may include: for each of the target component to be pasted, in response to detecting that an associated entity to which the pasted target component belongs does not comprise a component identical to the target component, creating the target component in the associated entity based on the target storage data corresponding to the target component that is stored in the clipboard, to obtain the target pasting data corresponding to the object to be copied.

Specifically, the associated entity to which the pasted target component belongs may be determined. For example, the associated entity corresponding to the target component may be determined based on the received operation information of the paste trigger operation. The operation information may include a pasting position of the target component, a name and an identifier of the associated entity, and the like.

In this embodiment, if a component identical to the target component is included, the paste operation may be completed based on the identical component, so as to simplify the paste operation. If a component identical to the target component is not included, the target component needs to be created in the associated entity. Specifically, the target component is created in the associated entity based on target storage data that is stored in the clipboard and corresponds to the target component, so as to obtain the target pasting data corresponding to the object to be copied.

This embodiment provides a manner of obtaining the target pasting data when the associated entity does not include a component identical to the target component. Thereby, the target pasting data of the object to be copied may be obtained effectively based on the target storage data, which is beneficial to quickly completing the paste operation of the target component.

Optionally, creating the target component in the associated entity based on the target storage data corresponding to the target component that is stored in the clipboard to obtain the target pasting data corresponding to the object to be copied includes: creating an engine object and a component object corresponding to the target component based on the engine object type field and the component object type field corresponding to the target component, respectively; obtaining engine attribute data of the engine object and component attribute data of the component object by deserializing the engine object serialized data and the component object serialized data corresponding to the target component, respectively; obtaining component pasting data corresponding to the target component by performing attribute data update on the engine object and the component object based on the engine attribute data and the component attribute data, respectively; and obtaining, based on the component pasting data, the target pasting data corresponding to the object to be copied.

In this embodiment, the target component type and the target engine type of the target component may be determined separately by using the engine object type field and the component object type field corresponding to the target component; and a component object having the target component type and an engine object having the target engine type are created. It should be noted that the component object may reflect the component structure information of the component of the target component type, and the engine object may reflect the engine structure information of the engine of the target engine type.

In order to obtain the component pasting data corresponding to the target component, the component object, the engine object and the target component need to have the same attribute. One specific implementation may include: obtaining engine attribute data of the engine object and component attribute data of the component object by deserializing the engine object serialized data and the component object serialized data corresponding to the target component, respectively;

performing attribute data update on the engine object based on the engine attribute data, so that the updated engine object can reflect the engine structure information and the engine attribute information at the same time; updating the component object through the component attribute data, so that the updated component object can reflect the component structure information and the component attribute information at the same time; the component pasting data of the target component may be determined based on the updated component object and the updated engine object; and the target pasting data is obtained based on the component pasting data.

If the object to be copied is a component to be copied, the component pasting data may be determined as the target pasting data. If the object to be copied is an entity to be copied, each component in the entity to be copied may be determined as a target component, and the target pasting data is composed of the component pasting data of respective target components.

The method has the advantages that by updating the component object and the engine object according to the attribute data, the component object and the engine object have attributes corresponding to the target component, and the target pasting data may be accurately and quickly determined.

In order to avoid a situation that the target component after pasting cannot be used in the associated entity, before creating the target component in the associated entity based on the target storage data corresponding to the target component that is stored in the clipboard, the method further comprises: obtaining a dependent component type of the target component based on the component object type field, and determining, based on the dependent component type, a dependent component in the associated entity that corresponds to the target component; and in response to the associated entity comprising the dependent component, performing an operation of creating the target component in the associated entity based on the target storage data corresponding to the target component that is stored in the clipboard.

The dependent component is a component that has a dependency relationship with the target component. When there is no dependent component in the associated entity that has a dependency relationship with the target component, the target component that is created in the associated entity cannot be used properly.

In specific implementations, in order to ensure that the target component can be used properly, the dependent component type may be determined based on the component object type field. Whether a dependent component is included in the associated entity is detected, and if the dependent component is included in the associated entity, the operation of creating the target component in the associated entity is performed; and if the dependent component is not included in the associated entity, a pop-up prompt may be performed for the user terminal to prompt that the paste operation on the object to be copied fails.

Specifically, the manner of detecting whether a dependent component is included in the associated entity includes: detecting whether a component of the dependent component type is included in the associated entity, and if a component of the dependent component type is included in the associated entity, it is determined that there is a dependent component in the associated entity; and if no component of the dependent component type is included in the associated entity, it is determined that there is no dependent component in the associated entity.

In this embodiment, before the target component is created, it is determined whether there is a dependent component in the associated entity, and if there is a dependent component in the associated entity, the operation of creating the target component is performed. Thereby, it is ensured that the created target component can be properly used in the associated entity.
2 The associated entity to which the pasted target component belongs includes a component identical to the target component.

Optionally, determining, based on the target storage data corresponding to the target component that is stored in the clipboard, target pasting data corresponding to the object to be copied includes: for each of the target component to be pasted, in response to detecting that an associated entity to which the pasted target component belongs comprises a component identical to the target component, determining the component identical to the target component as a component to be updated; and updating the component to be updated based on the target storage data corresponding to the target component that is stored in the clipboard, to obtain the target pasting data corresponding to the object to be copied.

If it is detected that the associated entity includes a component identical to the target component, it indicates that the target pasting data corresponding to the object to be copied may be obtained by determining the structure information of the target component based on the component identical to the target component in the associated entity and updating the attribute information of a component identical to the target component. Specifically, a component identical to the target component may be determined as the component to be updated. The component to be updated is updated based on the component object serialized data and the engine object serialized data in the target storage data, so that the updated component identical to the target component has the attribute of the target component, so as to obtain the target pasting data based on the updated component identical to the target component.

In this embodiment, for the case where the associated entity includes a component identical to the target component, the component identical to the target component may be determined as the component to be updated, and the update is performed based on the target storage data, so that the component to be updated has the attribute of the target component. Thereby, the target pasting data can be obtained without creating a new component.

In this embodiment, updating the component to be updated based on the target storage data corresponding to the target component that is stored in the clipboard to obtain the target pasting data corresponding to the object to be copied includes: obtaining engine attribute data of the engine object and component attribute data of the component object by deserializing the engine object serialized data and the component object serialized data corresponding to the target component, respectively; obtaining component pasting data corresponding to the target component by performing attribute data update on the engine object and the component object corresponding to the component to be updated based on the engine attribute data and the component attribute data, respectively; and obtaining, based on the component pasting data, the target pasting data corresponding to the object to be copied.

In a specific implementation, since both the engine object serialized data and the component object serialized data are data obtained after serialization processing, a predefined deserialization interface may be invoked to perform deserialization processing on the engine object serialized data and the component object serialized data, so as to obtain corresponding engine attribute data and component attribute data. The engine attribute data is assigned to the engine object corresponding to the component to be updated, and the component attribute data is assigned to the component object corresponding to the component to be updated, so as to complete the updating operation of the component to be updated, and make the attribute of the updated component to be updated to be the same as the target component. The component pasting data may be determined based on the updated component to be updated; and the target pasting data is determined based on the component pasting data.

According to the embodiment, by performing deserialization processing on the engine object serialized data and the component object serialized data, the engine attribute data and the component attribute data are determined. Thereby, convenience is provided for updating the component to be updated.

According to the technical solutions of embodiments of the present disclosure, the target pasting data corresponding to the object to be copied is determined based on the component object type field, the engine object type field, the component object serialized data and the engine object serialized data in the clipboard, so that the paste operation of the object to be copied is completed quickly and efficiently. In addition, after the target pasting data is obtained, the clipboard is emptied to save the space occupied by the clipboard.

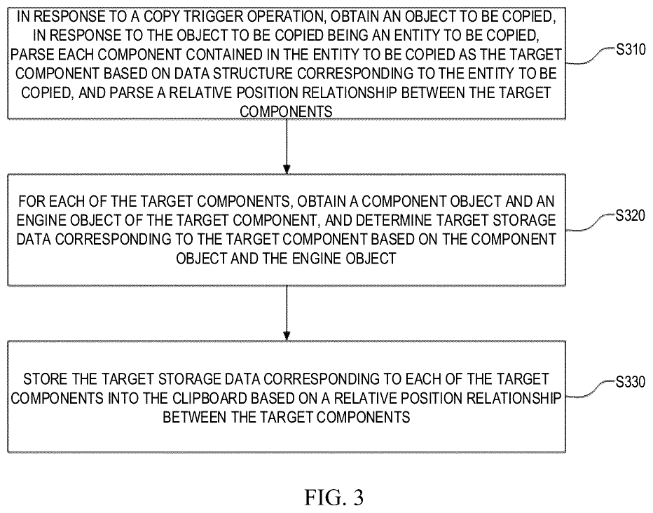

FIG. 3 is a schematic flowchart of a still further data processing method according to an embodiment of the present disclosure. On the basis of the above-described embodiments, the manner of determining the target component is refined in the technical solutions of these embodiments. For a situation where the object to be copied is the entity to be copied, the component(s) included in the entity to be copied is determined as the target component corresponding to the object to be copied. Specifically, each component contained in the entity to be copied is parsed as the target component based on data structure corresponding to the entity to be copied, and a relative position relationship between the target components is parsed. For the situation where the object to be copied is the entity to be copied, an implementation of storing the target storage data into the clipboard may include: storing the target storage data corresponding to each of the target components into the clipboard based on the relative position relationship between the target components.

For detailed implementation, reference may be made to the description of this embodiment. Technical features that are identical or similar to the foregoing embodiments are not described here again. As shown in FIG. 3, the method of this embodiment may specifically include:

S310: in response to a copy trigger operation, obtain an object to be copied, in response to the object to be copied being an entity to be copied, parse each component contained in the entity to be copied as the target component based on data structure corresponding to the entity to be copied, and parse a relative position relationship between the target components.

For example, the entity to be copied includes at least one sub-entity and/or at least one component, and the sub-entity includes at least one component. It should be noted that the structure of the entity to be copied may be displayed in the form of a tree structure. The data structure may be used to represent a relative position relationship between respective sub-entities and respective components included in the entity to be copied.

In this embodiment, each component included in the entity to be copied may be determined as a target component, and a relative position relationship between respective target components in the tree structure may be determined based on the data structure. For example, if the entity to be copied includes 1 sub-entity and 10 components, and the sub-entity includes 10 components, the entity to be copied is determined as a root node, 1 sub-entity and 10 components are determined as child nodes of the root node, and 10 components of the sub-entity are determined as child nodes of the child node corresponding to the sub-entity. Thereby, a relative position relationship between the target components may be determined.

S320: for each of the target components, obtain a component object and an engine object of the target component, and determine target storage data corresponding to the target component based on the component object and the engine object.

S330: store the target storage data corresponding to each of the target components into the clipboard based on a relative position relationship between the target components.

Specifically, the target storage data corresponding to the target components may be correspondingly stored based on the relative position relationship between the target components. Further, a component serialized data array and a sub-entity array may be stored in the clipboard. The component serialized data array includes target storage data corresponding to the target component in the entity or the sub-entity. The sub-entity array is used to reflect structural data of the sub-entity.

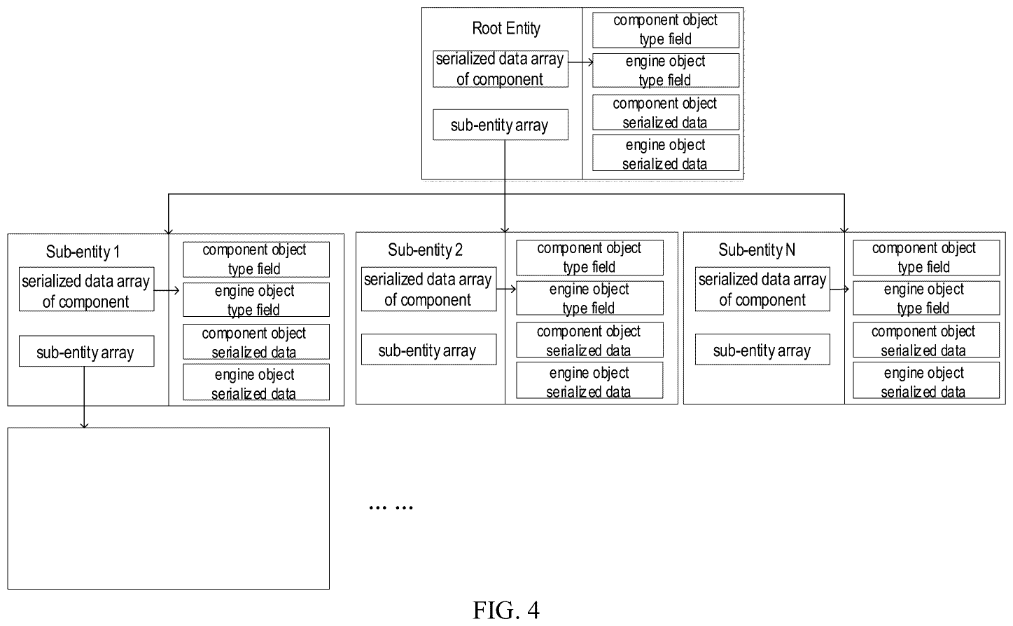

To describe in detail the format of the data stored in the clipboard in a case where the object to be copied is the entity to be copied, reference is made to FIG. 4. Each node in FIG. 4 includes a component serialized data array and a sub-entity array, the component serialized data array stores target storage data of respective target components corresponding to this node, and the sub-entity array stores structural data of a corresponding sub-entity of this node. The component serialized data array includes a component object type field, an engine object type field, component object serialized data, and engine object serialized data of the target component. For example, the entity to be copied may include N sub-entities, where N is a positive integer.

In this embodiment, for the entity to be copied with a relatively complex structure, the relative position relationship between the target components is parsed by using the data structure, and the target storage data is stored in the clipboard based on the relative position relationship, so that the relative position relationship between the components is ensured to be processed correctly in the copying process, which is beneficial to improving the accuracy and effectiveness in the copying process.

In this embodiment, after storing the target storage data corresponding to the target component into a clipboard, the method further includes: in response to a paste trigger operation inputted for the entity to be copied, determining component pasting data corresponding to each of the target components one by one based on the relative position relationship between the target components, to obtain entity pasting data corresponding to the entity to be copied.

The component pasting data includes a component object type field, an engine object type field, component object serialized data, and engine object serialized data corresponding to the target component. The entity pasting data corresponding to the entity to be copied may include component pasting data corresponding to respective target components and a relative position relationship between the respective target components.

In a specific implementation, before in response to a paste trigger operation inputted for the entity to be copied, whether a predetermined pasting condition is met is determined, and if the predetermined pasting condition is met, the paste trigger operation is responded to. For example, the paste trigger operation may include an operation such as clicking an “past” control, inputting a “past” voice instruction, and the like.

By way of example, the component serialized data array and the sub-entity array may be stored in the clipboard. The relative position relationship between the target components may be obtained based on the sub-entity array. Based on the relative position relationship and the component serialized data array corresponding to each node, the component serialized data of each target component is determined one by one as the component pasting data. The component pasting data constitutes the entity pasting data based on the relative position relationship.

In this embodiment, for the entity to be copied with relatively complex structure, the component pasting data corresponding to each target component is determined one by one based on the relative position relationship between the target components, so that the entity to be copied may be pasted according to the relative position relationship during copying. Thereby, it is ensured that the relative position relationship between the target components is not lost, and the accuracy of the paste operation is improved.

The embodiments corresponding to the data processing method are described in detail above, and in order to make those skilled in the art further clear about the technical solutions of the method, specific application scenarios are described below.

This embodiment may be applied to a scenario of copying and pasting an object in an ECS architecture. The embodiment provides a clipboard capable of storing data according to a predetermined data format. When the object to be copied is being copied, the corresponding target storage data may be stored into the clipboard according to a predetermined data format, that is, the component object type field, the engine object type field, the component object serialized data and the engine object serialized data are stored to the clipboard. Thereby, an engine does not exist in the clipboard, and thus problems of coupling and memory leakage or program crash are avoided.

Further, in this embodiment, the component serialization interface, the component deserialization interface, the entity serialization interface, and the entity deserialization interface corresponding to the clipboard are constructed. The component serialization interface and the component deserialization interface are used for serializing and deserializing the component data, respectively. Since the entity object includes a plurality of component objects and sub-entity object, the data structure is more complex. When the entity object is being copied, an entity serialization interface may be invoked, the data structure of the entity object is parsed, serialized data of the internal component of the entity object is obtained, and pasting of the entity object is realized through the entity deserialization interface when pasting.

The foregoing describes a clipboard provided in this embodiment. In order to describe a process of copying and pasting an object to be copied by using a clipboard more clearly and in detail, and an example in which the object to be copied is an entity to be copied and an example in which the object to be copied is a component to be copied may be taken as examples for description. 1. The object to be copied is a component to be copied.

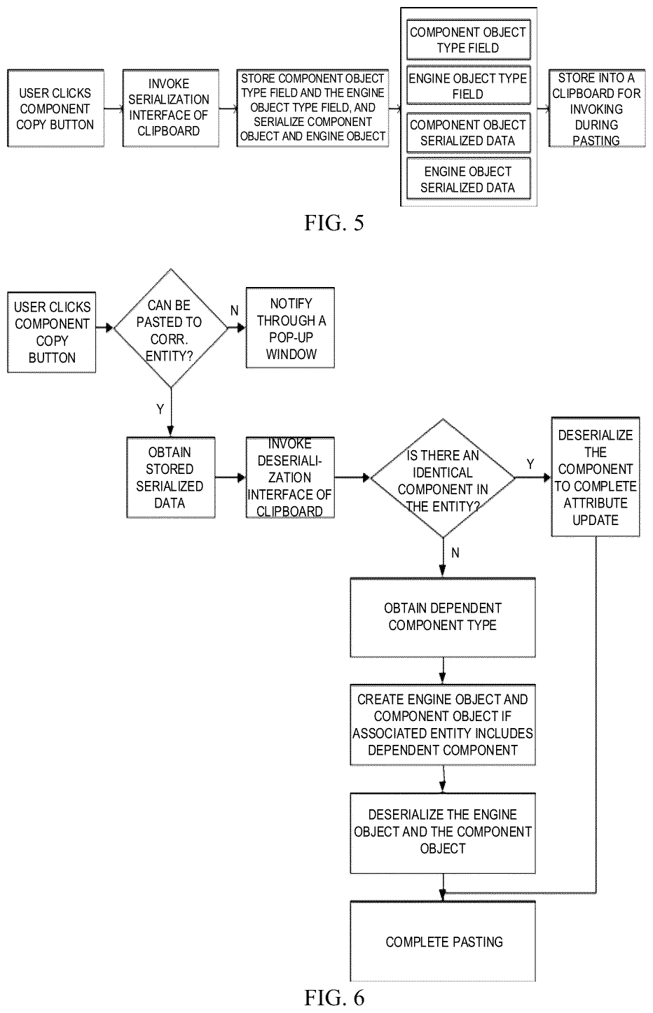

FIG. 5 is a schematic diagram of a copying process of a component to be copied according to an embodiment of the present disclosure. As shown in FIG. 5, a user generates a copy trigger operation by clicking a component copy button. When the copy trigger operation is detected, the serialization interface of the component may be invoked. The component object type field and the engine object type field are determined based on the type of the component to be copied, and the component attribute data of the component to be copied and the engine attribute data of the engine object are serialized to obtain the component object serialized data and the engine object serialized data. The component object type field, the engine object type field, the component object serialized data, and the engine object serialized data are stored into a clipboard for invoking during pasting.

FIG. 6 is a schematic diagram of a pasting process of a component to be copied according to an embodiment of the present disclosure. As shown in FIG. 6. a user generates a paste trigger operation by clicking a component paste button. When the paste trigger operation is detected, it needs to be determined whether the component to be copied corresponding to the paste trigger operation meets the predetermined pasting condition. If the predetermined pasting condition is not met, pasting failure information may be feedback with a pop-up window to prompt the pasting failure reason. If the predetermined pasting condition is met, the serialized data stored in the clipboard (i.e., the component object type field, the engine object type field, the component object serialized data, and the engine object serialized data) is obtained; and the deserialization interface of the component clipboard is invoked to complete the paste operation on the component to be copied.

Further, whether a component identical to the component to be copied exists in the associated entity to which the component to be copied belongs is determined based on the component object type field. If a component identical to the component to be copied exists in the associated entity, the component object serialized data and the engine object serialized data are deserialized through the deserialization interface to obtain the component attribute data and the engine attribute data corresponding to the component to be copied. The identical component is updated based on the component attribute data and the engine attribute data to complete the paste operation on the component to be copied. If a component identical to the component to be copied does not exist in the associated entity, a dependent component type is determined based on the component type field, and whether the associated entity includes a dependent component is determined based on the dependent component type. If the associated entity includes the dependent component, an engine object and a component object are created based on the engine object type field and the component object type field, and the paste operation on the component to be copied is completed by deserializing the engine object and the component object.
2. The object to be copied is an entity to be copied.

The entity to be copied includes at least one sub-entity and/or at least one component, and the sub-entity includes at least one component and/or at least one sub-entity. Therefore, the data obtained after the entity object is serialized is more complex, the format of storage data in the clipboard corresponding to the entity to be copied is shown in FIG. 4. Thereby, the serialized data of the entity object can be stored in the clipboard more clearly.

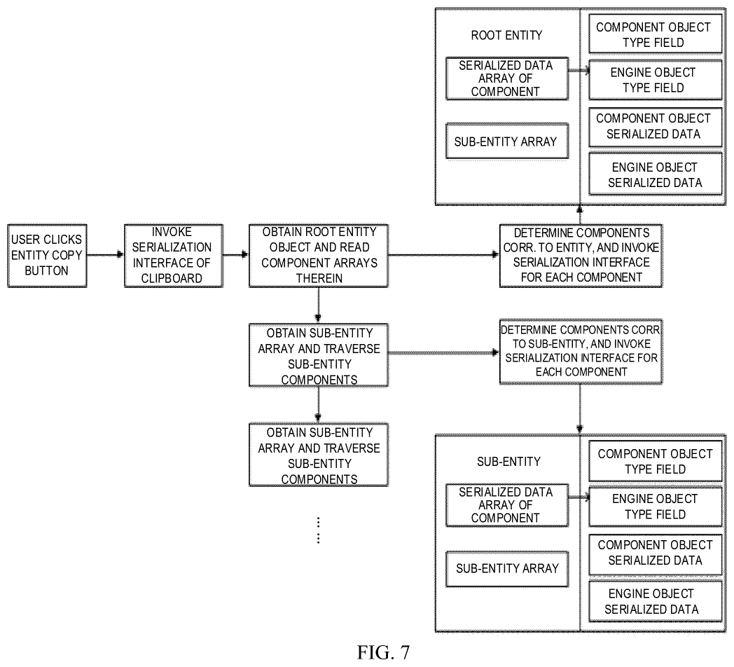

Based on the data structure in FIG. 4, a copying process of an entity to be copied provided by an embodiment of the present disclosure is shown in FIG. 7. In a specific implementation, after generating a copy trigger operation based on a click operation of a user, an entity clipboard serialization interface is invoked to obtain a root entity and read the component arrays therein, and the component arrays are traversed. All components included in the entity to which the component arrays belong may be determined based on the component arrays.

For each component included in each component root entity, the serialization interface is invoked to obtain the component object type field, the engine object type field, the component object serialized data, and the engine object serialized data; and the component object type field, the engine object type field, the component object serialized data and the engine object serialized data, the serialized data array of the component, and the sub-entity array are stored into the clipboard. For the sub-entity included in the root entity, the sub-entity array is obtained, and the sub-entity objects are traversed based on the sub-entity array; the component and the sub-entity included in the sub-entity are determined; for a sub-entity included in the sub-entity, the component and the sub-entity included in that sub-entity are determined again according to the corresponding sub-entity array until all the corresponding components are determined. For the component included in the sub-entity, the foregoing operations are repeated, and the component object type field, the engine object type field, the component object serialized data and the engine object serialized data, the serialized data array of the component, and the sub-entity array are stored into the clipboard.

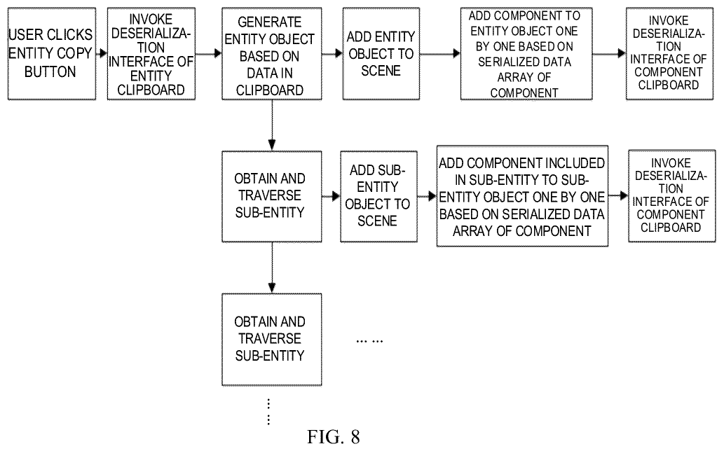

FIG. 8 is a schematic diagram of a pasting process of an entity to be copied according to an embodiment of the present disclosure. As shown in FIG. 8, after a user clicks an entity paste button, a deserialization interface corresponding to an entity may be invoked to obtain a serialized data array and a sub-entity array of a component stored in the clipboard.

Based on the serialized data array and the sub-entity array of the component, the component object included in the root entity corresponding to the entity to be copied may be determined. For each component object, the entity object corresponding to the entity to be copied is added in the scene, a component is added to the entity object one by one based on the serialized data array of the component, and the component deserialization interface is invoked to complete pasting of each component in the root entity of the entity to be copied.

Sub-entities included in an entity to be copied is determined based on the sub-entity array, and the respective sub-entities are traversed. For each sub-entity, each sub-entity object is added into the scene, a component(s) included in the sub-entity is added to the sub-entity object one by one based on the serialized data array of the component, and a deserialization interface of the component clipboard is invoked to complete pasting of each component. The paste operation on the entity to be copied is completed by pasting the components in the root entity and pasting the components in each layer of sub-entities.

It should be noted that, in the copying process, the component or the entity stores the data in the clipboard in a serialized manner. When the paste operation is performed, an object may be created by using the construct function, and the data in the clipboard may be deserialized to generate a corresponding component or entity. To ensure correct processing of a component or resource reference relationship, a unique identifier may be used during the serialization process. Specifically, when a component A refers to a component B or a resource object, one or more attributes within the component A may be set as an object or a resource object of corresponding component B, and when the component A is serialized, the corresponding attribute may be stored as the unique identifier of the corresponding component B or the resource object. In the deserialization operation, the corresponding component or resource object may be searched using the marked unique identifier, so as to ensure the correctness of the reference relationship between the component and the resource object in the copying and pasting process.

In the embodiment, the data format of the clipboard is set, so that the clipboard is simplified and cleaner; the situation of high coupling caused by storing engine is avoided while the memory occupation is reduced, and the stability of the software is not influenced. A unified serialization interface is realized, a correct copying of the entity object and the internal component object is ensured, and the correctness of the reference relationship between the components and the reference relationship of the resources is ensured by serializing the data in a data driving mode. Thereby, a more convenient and efficient use experience of the clipboard is brought, and better performance is provided for the copying and paste operation.

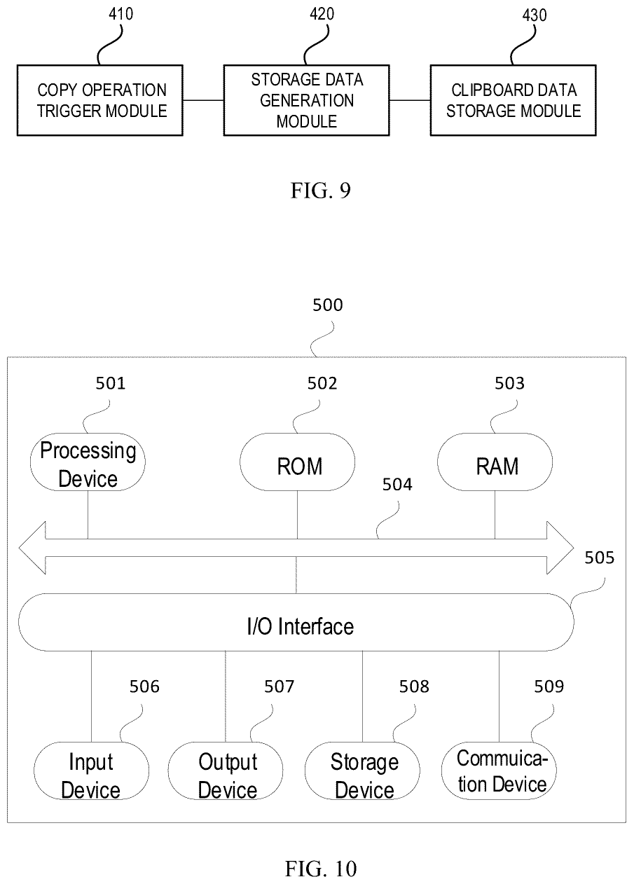

FIG. 9 is a schematic structural diagram of a data processing apparatus according to an embodiment of the present disclosure. As shown in FIG. 9, the apparatus comprises a copy operation trigger module 410, a storage data generation module 420, and a clipboard data storage module 430.

The copy operation trigger module 410 is configured for, in response to a copy trigger operation, obtaining an object to be copied, and determining a target component corresponding to the object to be copied.

The storage data generation module 420 is configured for, for each of the target component, obtaining a component object and an engine object of the target component, and determining target storage data corresponding to the target component based on the component object and the engine object, wherein the target storage data comprises a component object type field, an engine object type field, component object serialized data, and engine object serialized data.

The clipboard data storage module 430 is configured for storing the target storage data corresponding to the target component into a clipboard.

In some optional implementations, the storage data generation module 420 includes a component serialization interface invoking submodule configured for: invoking a predefined component serialization interface; determining a component object type field corresponding to the component object and an engine object type field corresponding to the engine object; and obtaining the component object serialized data and the engine object serialized data by serializing component attribute data of the component object and engine attribute data of the engine object, respectively.

In some optional implementations, the apparatus further includes a target pasting data determining module configured for: after storing the target storage data corresponding to the target component into the clipboard, in response to detecting that a predetermined pasting condition is met, determining target pasting data corresponding to the object to be copied, based on the target storage data corresponding to the target component that is stored in the clipboard.

In some optional implementations, the target pasting data determining module includes a target component creating submodule configured for: for each of the target component to be pasted, in response to detecting that an associated entity to which the pasted target component belongs does not comprise a component identical to the target component, creating the target component in the associated entity based on the target storage data corresponding to the target component that is stored in the clipboard, to obtain the target pasting data corresponding to the object to be copied.

In some optional implementations, the target component creating submodule includes: an engine object creating unit configured for creating an engine object and a component object corresponding to the target component based on the engine object type field and the component object type field corresponding to the target component, respectively; a first deserialization processing unit configured for obtaining engine attribute data of the engine object and component attribute data of the component object by deserializing the engine object serialized data and the component object serialized data corresponding to the target component, respectively; a first attribute data updating unit configured for obtaining component pasting data corresponding to the target component by performing attribute data update on the engine object and the component object based on the engine attribute data and the component attribute data, respectively; and obtaining, based on the component pasting data, the target pasting data corresponding to the object to be copied.

In some optional implementations, the target component creating submodule further includes: a dependent component determining unit configured for, before creating the target component in the associated entity based on the target storage data corresponding to the target component that is stored in the clipboard, obtaining a dependent component type of the target component based on the component object type field, and determining, based on the dependent component type, a dependent component in the associated entity that corresponds to the target component; an operation execution unit configured for, in response to the associated entity comprising the dependent component, performing an operation of creating the target component in the associated entity based on the target storage data corresponding to the target component that is stored in the clipboard.

In some optional implementations, the target pasting data determining module includes: a to-be-updated component determining submodule configured for, for each of the target component to be pasted, in response to detecting that an associated entity to which the pasted target component belongs comprises a component identical to the target component, determining the component identical to the target component as a component to be updated; a to-be-updated component updating submodule configured for updating the component to be updated based on the target storage data corresponding to the target component that is stored in the clipboard, to obtain the target pasting data corresponding to the object to be copied.

In some optional implementations, the to-be-updated component updating submodule includes: a second deserialization processing unit configured for obtaining engine attribute data of the engine object and component attribute data of the component object by deserializing the engine object serialized data and the component object serialized data corresponding to the target component, respectively; a second attribute data updating unit configured for obtaining component pasting data corresponding to the target component by performing attribute data update on the engine object and the component object corresponding to the component to be updated based on the engine attribute data and the component attribute data, respectively; and obtaining, based on the component pasting data, the target pasting data corresponding to the object to be copied.

In some optional implementations, optionally, the predetermined pasting condition comprises at least one of the following conditions: receiving a paste trigger operation inputted for the object to be copied; having a pasting permission for pasting the target component to a target pasting position; a paste operation permission being given for a to-be-pasted position corresponding to the target component; or an associated entity corresponding to the target component not comprising a component conflicting with the target component.

In some optional implementations, the copy operation trigger module 410 includes: a first target component determining submodule configured for, in response to that the object to be copied is a single component to be copied, determining the component to be copied as the target component; and a second target component determining submodule configured for, in response to that the object to be copied is an entity to be copied, determining a component comprised in the entity to be copied as the target component corresponding to the object to be copied.

In some optional implementations, optionally, the entity to be copied comprises at least one sub-entity and/or at least one component, and the sub-entity comprises at least one component. The second target component determining submodule includes a relative position relationship determining unit configured for: parsing, based on data structure corresponding to the entity to be copied, each component contained in the entity to be copied as target components, and parsing a relative position relationship between the target components. The clipboard data storage module 430 includes a clipboard data storage submodule configured for store the target storage data corresponding to each of the target components into the clipboard based on the relative position relationship between the target components.

In some optional implementations, the clipboard data storage submodule further includes an entity pasting data obtaining unit configured for, after storing the target storage data corresponding to the target component into the clipboard, in response to a paste trigger operation inputted for the entity to be copied, determining component pasting data corresponding to each of the target components one by one based on the relative position relationship between the target components, to obtain entity pasting data corresponding to the entity to be copied.

According to technical solutions provided by the embodiment of the present disclosure, in response to a copy trigger operation, an object to be copied is obtained, and a target component corresponding to the object to be copied is determined, so as to complete a copy operation on the object to be copied by performing a copy operation on each of the target component; for each of the target component, a component object and an engine object of the target component is obtained, and target storage data corresponding to the target component is determined based on the component object and the engine object, so that the target storage data can reflect the characteristics of the component object and the engine object; and the target storage data corresponding to the target component is stored into a clipboard, so as to complete copying the target component. Since the target storage data comprises a component object type field, an engine object type field, component object serialized data, and engine object serialized data, i.e., the engine itself is not stored into the clipboard, the problem of memory leakage or program crash caused by engine coupling is solved, meanwhile memory occupation caused by the copy operation is reduced, and thus system stability is improved. Furthermore, in aid of storing the component object type field, the engine object type field, the component object serialized data and the engine object serialized data into the clipboard, the data format stored in the clipboard is more simplified and cleaner, and easy to maintain.

The data processing apparatus provided in the embodiments of the present disclosure may perform the data processing method provided by any of embodiments of the present disclosure, and has functional modules and beneficial effects corresponding to executing the method.

It should be noted that the units and modules included in the foregoing apparatus are only divided according to the function logic, but are not limited to the foregoing division, as long as the corresponding functions may be implemented. In addition, the specific names of the functional units are merely for ease of distinguishing, and are not intended to limit the protection scope of the embodiments of the present disclosure.

FIG. 10 is a schematic structural diagram of an electronic device according to an embodiment of the present disclosure. Reference is made to FIG. 10, which illustrates a schematic structural diagram of an electronic device (such as the terminal device or server in FIG. 10) 500 suitable for implementing the embodiments of the present disclosure. The terminal device in the embodiments of the present disclosure may include, but is not limited to, a mobile terminal such as a mobile phone, a laptop computer, a digital broadcast receiver, a PDA (personal digital assistant), a PAD (portable android device), a PMP (portable multimedia player), an in-vehicle terminal (for example, an in-vehicle navigation terminal), and a fixed terminal such as a digital TV, a desktop computer, or the like. The electronic device shown in FIG. 10 is merely an example, and should not impose any limitation on the functions and scope of use of the embodiments of the present disclosure.

As shown in FIG. 10, the electronic device 500 may include a processing device (for example, a central processing unit, a graphics processor, etc.) 501, which may perform various appropriate actions and processing according to a program stored in a read-only memory (ROM) 502 or a program loaded into a random access memory (RAM) 503 from a storage device 508. In the RAM 503, various programs and data required for the operation of the electronic device 500 are also stored. The processing device 501, the ROM 502, and the RAM 503 are connected to each other through a bus 504. An input/output (I/O) interface 505 is also connected to the bus 504.

Generally, the following devices may be connected to the I/O interface 505: an input device 506 including, for example, a touch screen, a touchpad, a keyboard, a mouse, a camera, a microphone, an accelerometer, a gyroscope, etc.; an output device 507 including, for example, a liquid crystal display (LCD), a speaker, a vibrator, etc.; a storage device 508 including, for example, a magnetic tape, a hard disk, etc.; and a communication device 509. The communication device 509 may allow the electronic device 500 to communicate wirelessly or wired with other devices to exchange data. While FIG. 10 shows an electronic device 500 having various devices, it should be understood that it is not required to implement or have all illustrated devices. More or fewer devices may alternatively be implemented or provided.

In particular, according to an embodiment of the present disclosure, the process described above with reference to the flowchart may be implemented as a computer software program. For example, embodiments of the present disclosure include a computer program product comprising a computer program carried on a non-transitory computer readable medium, the computer program comprising program code for performing the method shown in the flowchart. In such embodiments, the computer program may be downloaded and installed from the network through the communication device 509, or installed from the storage device 508, or from the ROM 502. When the computer program is executed by the processing apparatus 501, the foregoing functions defined in the method of the embodiments of the present disclosure are performed.

The names of messages or information interacted between multiple devices in embodiments of the present disclosure are for illustrative purposes only and are not intended to limit the scope of such messages or information.

The electronic device provided by the embodiments of the present disclosure and the data processing method provided in the foregoing embodiments belong to the same inventive concept, technical details not described in detail in this embodiment may refer to the foregoing embodiments, and this embodiment has the same beneficial effects as the foregoing embodiments.

An embodiment of the present disclosure provides a computer storage medium having a computer program stored thereon. The program, when executed by a processor, implements the data processing method provided in the foregoing embodiments.

It should be noted that the computer-readable medium described above may be a computer readable signal medium, a computer readable storage medium, or any combination of the foregoing two. The computer-readable storage medium may be, for example—but not limited to—an electrical, magnetic, optical, electromagnetic, infrared, or semiconductor system, device, or device, or any combination thereof. More specific examples of computer-readable storage media may include, but are not limited to, an electrical connection having one or more wires, a portable computer diskette, a hard disk, a random access memory (RAM), a read-only memory (ROM), an erasable programmable read-only memory (EPROM or Flash memory), an optical fiber, a portable compact disk read-only memory (CD-ROM), an optical storage device, a magnetic storage device, or any suitable combination of the foregoing. In the present disclosure, a computer-readable storage medium may be any tangible medium containing or storing a program that may be used by or in connection with an instruction execution system, apparatus, or device. In the present disclosure, a computer readable signal medium may include a data signal propagated in baseband or as part of a carrier, where the computer readable program code is carried. Such propagated data signals may take a variety of forms including, but not limited to, electromagnetic signals, optical signals, or any suitable combination of the foregoing. The computer readable signal medium may also be any computer readable medium other than a computer readable storage medium that may send, propagate, or transmit a program for use by or in connection with an instruction execution system, apparatus, or device. The program code embodied on the computer-readable medium may be transmitted with any suitable medium, including but not limited to: wires, optical cables, RF (radio frequency), and the like, or any suitable combination of the foregoing.

In some implementations, the client and server may communicate using any currently known or future developed network protocol, such as HTTP (Hypertext Transfer Protocol), and may be interconnected with any form or medium of digital data communication (e.g., a communication network). Examples of communication networks include local area networks (“LANs”), wide area networks (“WANs”), internets (e.g., the Internet), and peer-to-peer networks (e.g., ad hoc peer-to-peer networks), as well as any currently known or future developed networks.

The computer-readable medium described above may be included in the electronic device; or may be separately present without being assembled into the electronic device.

The computer readable medium carries one or more programs. The one or more programs, when executed by the electronic device, cause the electronic device to: in response to a copy trigger operation, obtain an object to be copied, and determine a target component corresponding to the object to be copied; for each of the target component, obtain a component object and an engine object of the target component, and determine target storage data corresponding to the target component based on the component object and the engine object, wherein the target storage data comprises a component object type field, an engine object type field, component object serialized data, and engine object serialized data; and store the target storage data corresponding to the target component into a clipboard.

Computer program code for performing the operations of the present disclosure may be written in one or more programming languages, including, but not limited to, object oriented programming languages, such as Java, Smalltalk, C++, and conventional procedural programming languages, such as C language or similar programming languages. The program code may be executed entirely on a user computer, partially on a user computer, as a stand-alone software package, partially on a user computer and partially on a remote computer, or entirely on a remote computer or server. In the case of a remote computer, the remote computer may be connected to the user computer through any kind of network, including a local area network (LAN) or a wide area network (WAN), or may be connected to an external computer (e.g., connected through the Internet using an Internet service provider).

The flowcharts and block diagrams in the figures illustrate architecture, functionality, and operation of possible implementations of systems, methods, and computer program products according to various embodiments of the present disclosure. In this regard, each block in the flowchart or block diagram may represent a module, program segment, or portion of code that includes one or more executable instructions for implementing the specified logical function. It should also be noted that in some alternative implementations, the functions noted in the blocks may also occur in an order different from that illustrated in the figures. For example, two consecutively represented blocks may actually be performed substantially in parallel, and sometimes they may be performed in the reverse order, depending on the functionality involved. It is also noted that each block in the block diagrams and/or flowcharts, as well as combinations of blocks in the block diagrams and/or flowcharts, may be implemented with a dedicated hardware-based system that performs the specified functions or operations, or may be implemented in a combination of dedicated hardware and computer instructions.

The units involved in the embodiments of the present disclosure may be implemented in software, or may be implemented in hardware. The name of a unit does not constitute a limitation on the unit itself under certain circumstances. For example, the first obtaining unit may be further described as “a unit for obtaining at least two Internet Protocol addresses”.

The functions described above may be performed, at least in part, by one or more hardware logic components. By way of example rather than limitation, example types of hardware logic components that may be used include: field programmable gate array (FPGA), application specific integrated circuit (ASIC), application specific standard product (ASSP), system-on-a-chip (SOC), complex programmable logic device (CPLD), and the like.

In the context of the present disclosure, a machine-readable medium may be a tangible medium that may contain or store a program for use by or in connection with an instruction execution system, apparatus, or device. The machine-readable medium may be a machine-readable signal medium or a machine-readable storage medium. The machine-readable medium may include, but is not limited to, electronic, magnetic, optical, electromagnetic, infrared, or semiconductor systems, devices, or devices, or any suitable combination of the foregoing. More specific examples of machine-readable storage media may include electrical connections based on one or more lines, portable computer disks, hard disks, random access memory (RAM), read-only memory (ROM), erasable programmable read-only memory (EPROM or Flash memory), optical fibers, portable compact disc read-only memory (CD-ROM), optical storage devices, magnetic storage devices, or any suitable combination of the foregoing.

According to one or more embodiments of the present disclosure, [Example 1] provides a data processing method including: in response to a copy trigger operation, obtaining an object to be copied, and determining a target component corresponding to the object to be copied; for each of the target component, obtaining a component object and an engine object of the target component, and determining target storage data corresponding to the target component based on the component object and the engine object, wherein the target storage data comprises a component object type field, an engine object type field, component object serialized data, and engine object serialized data; and storing the target storage data corresponding to the target component into a clipboard.

According to one or more embodiments of the present disclosure, [Example 2] provides a data processing method, further comprising: in some optional implementations, invoking a predefined component serialization interface; determining a component object type field corresponding to the component object and an engine object type field corresponding to the engine object; and obtaining the component object serialized data and the engine object serialized data by serializing component attribute data of the component object and engine attribute data of the engine object, respectively.

According to one or more embodiments of the present disclosure, [Example 3] provides a data processing method, further comprising: in some optional implementations, after storing the target storage data corresponding to the target component into the clipboard, in response to detecting that a predetermined pasting condition is met, determining target pasting data corresponding to the object to be copied, based on the target storage data corresponding to the target component that is stored in the clipboard.

According to one or more embodiments of the present disclosure, [Example 4] provides a data processing method, further comprising: in some optional implementations, for each of the target component to be pasted, in response to detecting that an associated entity to which the pasted target component belongs does not comprise a component identical to the target component, creating the target component in the associated entity based on the target storage data corresponding to the target component that is stored in the clipboard, to obtain the target pasting data corresponding to the object to be copied.

According to one or more embodiments of the present disclosure, [Example 5] provides a data processing method, further comprising: in some optional implementations, creating an engine object and a component object corresponding to the target component based on the engine object type field and the component object type field corresponding to the target component, respectively; obtaining engine attribute data of the engine object and component attribute data of the component object by deserializing the engine object serialized data and the component object serialized data corresponding to the target component, respectively; obtaining component pasting data corresponding to the target component by performing attribute data update on the engine object and the component object based on the engine attribute data and the component attribute data, respectively; and obtaining, based on the component pasting data, the target pasting data corresponding to the object to be copied.

According to one or more embodiments of the present disclosure, [Example 6] provides a data processing method, further comprising: in some optional implementations, before creating the target component in the associated entity based on the target storage data corresponding to the target component that is stored in the clipboard, obtaining a dependent component type of the target component based on the component object type field, and determining, based on the dependent component type, a dependent component in the associated entity that corresponds to the target component; and in response to the associated entity comprising the dependent component, performing an operation of creating the target component in the associated entity based on the target storage data corresponding to the target component that is stored in the clipboard.

According to one or more embodiments of the present disclosure, [Example 7] provides a data processing method, further comprising: in some optional implementations, for each of the target component to be pasted, in response to detecting that an associated entity to which the pasted target component belongs comprises a component identical to the target component, determining the component identical to the target component as a component to be updated; and updating the component to be updated based on the target storage data corresponding to the target component that is stored in the clipboard, to obtain the target pasting data corresponding to the object to be copied.

According to one or more embodiments of the present disclosure, [Example 8] provides a data processing method, further comprising: in some optional implementations, obtaining engine attribute data of the engine object and component attribute data of the component object by deserializing the engine object serialized data and the component object serialized data corresponding to the target component, respectively; obtaining component pasting data corresponding to the target component by performing attribute data update on the engine object and the component object corresponding to the component to be updated based on the engine attribute data and the component attribute data, respectively; and obtaining, based on the component pasting data, the target pasting data corresponding to the object to be copied.

According to one or more embodiments of the present disclosure, [Example 9] provides a data processing method, further comprising: in some optional implementations, the predetermined pasting condition comprises at least one of the following conditions: receiving a paste trigger operation inputted for the object to be copied; having a pasting permission for pasting the target component to a target pasting position; a paste operation permission being given for a to-be-pasted position corresponding to the target component; or an associated entity corresponding to the target component not comprising a component conflicting with the target component.

According to one or more embodiments of the present disclosure, [Example 10] provides a data processing method, further comprising: in some optional implementations, in response to that the object to be copied is a single component to be copied, determining the component to be copied as the target component; in response to that the object to be copied is an entity to be copied, determining a component comprised in the entity to be copied as the target component corresponding to the object to be copied.

According to one or more embodiments of the present disclosure, [Example 11] provides a data processing method, further comprising: in some optional implementations, the entity to be copied comprises at least one sub-entity and/or at least one component, and the sub-entity comprises at least one component. Correspondingly, determining the component comprised in the entity to be copied as the target component corresponding to the object to be copied comprises: parsing, based on data structure corresponding to the entity to be copied, each component contained in the entity to be copied as target components, and parsing a relative position relationship between the target components. Storing the target storage data corresponding to the target component into the clipboard comprises: storing the target storage data corresponding to each of the target components into the clipboard based on the relative position relationship between the target components.

According to one or more embodiments of the present disclosure, [Example 12] provides a data processing method, further comprising: in some optional implementations, after storing the target storage data corresponding to the target component into the clipboard, in response to a paste trigger operation inputted for the entity to be copied, determining component pasting data corresponding to each of the target components one by one based on the relative position relationship between the target components, to obtain entity pasting data corresponding to the entity to be copied.

According to one or more embodiments of the present disclosure, [Example 13] provides a data processing apparatus, comprising: a copy operation trigger module, configured for, in response to a copy trigger operation, obtaining an object to be copied, and determining a target component corresponding to the object to be copied; a storage data generation module, configured for, for each of the target component, obtaining a component object and an engine object of the target component, and determining target storage data corresponding to the target component based on the component object and the engine object, wherein the target storage data comprises a component object type field, an engine object type field, component object serialized data, and engine object serialized data; and a clipboard data storage module, configured for storing the target storage data corresponding to the target component into a clipboard.

According to the embodiment of the present disclosure, in response to a copy trigger operation, an object to be copied is obtained, and a target component corresponding to the object to be copied is determined, so as to complete a copy operation on the object to be copied by performing a copy operation on each of the target component; for each of the target component, a component object and an engine object of the target component is obtained, and target storage data corresponding to the target component is determined based on the component object and the engine object, so that the target storage data can reflect the characteristics of the component object and the engine object; and the target storage data corresponding to the target component is stored into a clipboard, so as to complete copying the target component. Since the target storage data comprises a component object type field, an engine object type field, component object serialized data, and engine object serialized data, i.e., the engine itself is not stored into the clipboard, the problem of memory leakage or program crash caused by engine coupling is solved, meanwhile memory occupation caused by the copy operation is reduced, and thus system stability is improved. Furthermore, in aid of storing the component object type field, the engine object type field, the component object serialized data and the engine object serialized data into the clipboard, the data format stored in the clipboard is more simplified and cleaner, and easy to maintain.

The above description is merely an illustration of the preferred embodiments of the present disclosure and the principles of the application. It should be understood by those skilled in the art that the disclosure in the present disclosure is not limited to the technical solutions of the specific combination of the above technical features, and should also cover other technical solutions formed by any combination of the above technical features or their equivalent features without departing from the above disclosed concept, for example, a technical solution formed by replacing technical features disclosed in the present disclosure (but not limited to them) with the above features.

Further, while operations are depicted in a particular order, this should not be understood to require that these operations be performed in the particular order shown or in sequential order. In certain circumstances, multitasking and parallel processing may be advantageous. Likewise, while several specific implementation details are included in the discussion above, these should not be construed as limiting the scope of the present disclosure. Certain features described in the context of separate embodiments may also be implemented in combination in a single embodiment. On the contrary, the various features described in the context of a single embodiment may also be implemented in multiple embodiments either individually or in any suitable sub-combination.

Although the present subject matter has been described in language specific to structural features and/or methodological acts, it is to be understood that the subject matter defined in the appended claims is not necessarily limited to the specific features or acts described above. Rather, the specific features and acts described above are merely example forms of implementing the claims.

I/We claim:

1. A data processing method, comprising:
in response to a copy trigger operation, obtaining an object to be copied, and determining a target component corresponding to the object to be copied;
for each of the target component, obtaining a component object and an engine object of the target component, and determining target storage data corresponding to the target component based on the component object and the engine object, wherein the target storage data comprises a component object type field, an engine object type field, component object serialized data, and engine object serialized data; and
storing the target storage data corresponding to the target component into a clipboard.

2. The data processing method of claim 1, wherein determining the target storage data corresponding to the target component based on the component object and the engine object comprises:
invoking a predefined component serialization interface;
determining a component object type field corresponding to the component object and an engine object type field corresponding to the engine object; and
obtaining the component object serialized data and the engine object serialized data by serializing component attribute data of the component object and engine attribute data of the engine object, respectively.

3. The data processing method of claim 1, wherein after storing the target storage data corresponding to the target component into the clipboard, the method further comprises:
in response to detecting that a predetermined pasting condition is met, determining target pasting data corresponding to the object to be copied, based on the target storage data corresponding to the target component that is stored in the clipboard.

4. The data processing method of claim 3, wherein determining the target pasting data corresponding to the object to be copied based on the target storage data corresponding to the target component that is stored in the clipboard comprises:
for each of the target component to be pasted, in response to detecting that an associated entity to which the pasted target component belongs does not comprise a component identical to the target component, creating the target component in the associated entity based on the target storage data corresponding to the target component that is stored in the clipboard, to obtain the target pasting data corresponding to the object to be copied.

5. The data processing method of claim 4, wherein creating the target component in the associated entity based on the target storage data corresponding to the target component that is stored in the clipboard to obtain the target pasting data corresponding to the object to be copied comprises:
creating an engine object and a component object corresponding to the target component based on the engine object type field and the component object type field corresponding to the target component, respectively;
obtaining engine attribute data of the engine object and component attribute data of the component object by deserializing the engine object serialized data and the component object serialized data corresponding to the target component, respectively;
obtaining component pasting data corresponding to the target component by performing attribute data update on the engine object and the component object based on the engine attribute data and the component attribute data, respectively; and
obtaining, based on the component pasting data, the target pasting data corresponding to the object to be copied.

6. The data processing method of claim 4, wherein before creating the target component in the associated entity based on the target storage data corresponding to the target component that is stored in the clipboard, the method further comprises:
obtaining a dependent component type of the target component based on the component object type field, and determining, based on the dependent component type, a dependent component in the associated entity that corresponds to the target component; and
in response to the associated entity comprising the dependent component, performing an operation of creating the target component in the associated entity based on the target storage data corresponding to the target component that is stored in the clipboard.

7. The data processing method of claim 3, wherein determining, based on the target storage data corresponding to the target component that is stored in the clipboard, target pasting data corresponding to the object to be copied comprises:
for each of the target component to be pasted, in response to detecting that an associated entity to which the pasted target component belongs comprises a component identical to the target component, determining the component identical to the target component as a component to be updated; and
updating the component to be updated based on the target storage data corresponding to the target component that is stored in the clipboard, to obtain the target pasting data corresponding to the object to be copied.

8. The data processing method of claim 7, wherein updating the component to be updated based on the target storage data corresponding to the target component that is stored in the clipboard to obtain the target pasting data corresponding to the object to be copied comprises:
obtaining engine attribute data of the engine object and component attribute data of the component object by deserializing the engine object serialized data and the component object serialized data corresponding to the target component, respectively;
obtaining component pasting data corresponding to the target component by performing attribute data update on the engine object and the component object corresponding to the component to be updated based on the engine attribute data and the component attribute data, respectively; and
obtaining, based on the component pasting data, the target pasting data corresponding to the object to be copied.

9. The data processing method of claim 3, wherein the predetermined pasting condition comprises at least one of the following conditions:
receiving a paste trigger operation inputted for the object to be copied;
having a pasting permission for pasting the target component to a target pasting position;
a paste operation permission being given for a to-be-pasted position corresponding to the target component; or
an associated entity corresponding to the target component not comprising a component conflicting with the target component.

10. The data processing method of claim 1, wherein determining the target component corresponding to the object to be copied comprises:
in response to that the object to be copied is a single component to be copied, determining the component to be copied as the target component;
in response to that the object to be copied is an entity to be copied, determining a component comprised in the entity to be copied as the target component corresponding to the object to be copied.

11. The data processing method of claim 10, wherein the entity to be copied comprises at least one sub-entity and/or at least one component, and the sub-entity comprises at least one component;
determining the component comprised in the entity to be copied as the target component corresponding to the object to be copied comprises: parsing, based on data structure corresponding to the entity to be copied, each component contained in the entity to be copied as target components, and parsing a relative position relationship between the target components; and
storing the target storage data corresponding to the target component into the clipboard comprises: storing the target storage data corresponding to each of the target components into the clipboard based on the relative position relationship between the target components.

12. The data processing method according to claim 11, wherein after storing the target storage data corresponding to the target component into the clipboard, the method further comprises:
in response to a paste trigger operation inputted for the entity to be copied, determining component pasting data corresponding to each of the target components one by one based on the relative position relationship between the target components, to obtain entity pasting data corresponding to the entity to be copied.

13. An electronic device, comprising:
one or more processors; and
a storage device, configured to store one or more programs,
wherein the one or more programs, when executed by the one or more processors, cause the one or more processors to perform acts comprising:
in response to a copy trigger operation, obtaining an object to be copied, and determining a target component corresponding to the object to be copied;
for each of the target component, obtaining a component object and an engine object of the target component, and determining target storage data corresponding to the target component based on the component object and the engine object, wherein the target storage data comprises a component object type field, an engine object type field, component object serialized data, and engine object serialized data; and
storing the target storage data corresponding to the target component into a clipboard.

14. The electronic device of claim 13, wherein determining the target storage data corresponding to the target component based on the component object and the engine object comprises:
invoking a predefined component serialization interface;
determining a component object type field corresponding to the component object and an engine object type field corresponding to the engine object; and
obtaining the component object serialized data and the engine object serialized data by serializing component attribute data of the component object and engine attribute data of the engine object, respectively.

15. The electronic device of claim 13, wherein after storing the target storage data corresponding to the target component into the clipboard, the acts further comprise:
in response to detecting that a predetermined pasting condition is met, determining target pasting data corresponding to the object to be copied, based on the target storage data corresponding to the target component that is stored in the clipboard.

16. The electronic device of claim 15, wherein determining the target pasting data corresponding to the object to be copied based on the target storage data corresponding to the target component that is stored in the clipboard comprises:
for each of the target component to be pasted, in response to detecting that an associated entity to which the pasted target component belongs does not comprise a component identical to the target component, creating the target component in the associated entity based on the target storage data corresponding to the target component that is stored in the clipboard, to obtain the target pasting data corresponding to the object to be copied.

17. The electronic device of claim 16, wherein creating the target component in the associated entity based on the target storage data corresponding to the target component that is stored in the clipboard to obtain the target pasting data corresponding to the object to be copied comprises:
creating an engine object and a component object corresponding to the target component based on the engine object type field and the component object type field corresponding to the target component, respectively;
obtaining engine attribute data of the engine object and component attribute data of the component object by deserializing the engine object serialized data and the component object serialized data corresponding to the target component, respectively;
obtaining component pasting data corresponding to the target component by performing attribute data update on the engine object and the component object based on the engine attribute data and the component attribute data, respectively; and
obtaining, based on the component pasting data, the target pasting data corresponding to the object to be copied.

18. The electronic device of claim 16, wherein before creating the target component in the associated entity based on the target storage data corresponding to the target component that is stored in the clipboard, the method further comprises:
obtaining a dependent component type of the target component based on the component object type field, and determining, based on the dependent component type, a dependent component in the associated entity that corresponds to the target component; and
in response to the associated entity comprising the dependent component, performing an operation of creating the target component in the associated entity based on the target storage data corresponding to the target component that is stored in the clipboard.

19. The electronic device of claim 15, wherein determining, based on the target storage data corresponding to the target component that is stored in the clipboard, target pasting data corresponding to the object to be copied comprises:
for each of the target component to be pasted, in response to detecting that an associated entity to which the pasted target component belongs comprises a component identical to the target component, determining the component identical to the target component as a component to be updated; and
updating the component to be updated based on the target storage data corresponding to the target component that is stored in the clipboard, to obtain the target pasting data corresponding to the object to be copied.

20. A non-transitory storage medium comprising computer-executable instructions, wherein the computer-executable instructions, when executed by a computer processor, perform acts comprising:
in response to a copy trigger operation, obtaining an object to be copied, and determining a target component corresponding to the object to be copied;
for each of the target component, obtaining a component object and an engine object of the target component, and determining target storage data corresponding to the target component based on the component object and the engine object, wherein the target storage data comprises a component object type field, an engine object type field, component object serialized data, and engine object serialized data; and
storing the target storage data corresponding to the target component into a clipboard.
